(19) United States
(12) Patent Application Publication
(10) Pub. No.: US 2026/0194678 A1
(43) Pub. Date: Jul. 9, 2026

(54) SYSTEMS AND METHODS FOR ACOUSTIC PROCESSING AT AN EDGE DEVICE

(71) Applicant: SCHLUMBERGER TECHNOLOGY CORPORATION, Sugar Land, TX (US)

(72) Inventor: Takeshi ENDO, Sugar Land, TX (US)

(21) Appl. No.: 19/129,681

(22) PCT Filed: Nov. 15, 2023
(86) PCT No.: PCT/US2023/079793

§ 371 Date: May 14, 2025

Related U.S. Application Data
(60) Provisional application No. 63/383,781, filed on Nov. 15, 2022.

(51) Int. Cl. G01V 1/48; G01V 1/46

(52) U.S. Cl. CPC G01V 1/48; G01V 1/46; G01V 2200/16; G01V 2210/72

(57) ABSTRACT

The disclosed techniques relate to techniques for generating processed waveform data using an edge device. For example, the techniques include receiving, via one or more processors of an edge device, a processing request transmitted by a computing device associated with acoustic measurement data; determining, via the one or processors, one or more processing parameters based on the processing request; retrieving, via the one or more processors, the acoustic measurement data; generating, via the one or more processors, processed acoustic measurement data based on the one or more processing parameters; generating, via the one or more processors, processed acoustic measurement output based on the processed acoustic measurement data; and outputting, via the one or more processors, the processed acoustic measurement output to the computing device.

### CROSS-REFERENCE TO RELATED APPLICATIONS

The present patent application is an International Application that claims priority to U.S. Provisional Patent Application No. 63/383,781 that was filed on Nov. 15, 2022, which is herein incorporated by reference in its entirety.

### FIELD OF DISCLOSURE

Aspects of the disclosure relate generally to downhole tools. More specifically, aspects of the disclosure relate to techniques for managing computational resources generating processed data using acoustic waveform data.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

The oil and gas industry includes a number of sub-industries, such as exploration, drilling, logging, extraction, transportation, refinement, retail, and so forth. During exploration and drilling, wellbores may be drilled into the ground for reasons that may include discovery, observation, and/or extraction of resources. These resources may include oil, gas, water, or any other combination of elements within the ground.

Acoustics logging plays an important role in both reservoir evaluation and well construction. In general, the data acquisition is performed downhole by firing a transmitter and then recording waveforms with array of receivers. A signal processing technique is applied to the waveforms to obtain formation and borehole properties in downhole and surface computers at wellsite.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one example embodiment, a processing method is provided. The method may include receiving, via one or more processors associated with an edge device, a processing request transmitted by a computing device associated with acoustic measurement data, determining, via the one or more processors, one or more processing parameters based on the processing request, retrieving, via the one or more processors, the acoustic measurement data, generating, via the one or more processors, processed acoustic measurement data based on the one or more processing parameters, generating, via the one or more processors, a processed acoustic measurement output based on the processed acoustic measurement data, and outputting, via the one or more processors, the processed acoustic measurement output to the computing device.

In another example embodiment, an edge-based acoustic processing system is disclosed. The edge-based acoustic processing system may include a remote computing device and an edge-based processing system communicatively coupled to the remote computing device, wherein the edge-based processing system may include one or more processors and one or more memory devices. The one or more processors may be configured to receive a processing request transmitted by the remote computing device associated with acoustic measurement data, determine one or more processing parameters based on the processing request, retrieve the acoustic measurement data, generate processed acoustic measurement data based on the one or more processing parameters, generate a processed acoustic measurement output based on the processed acoustic measurement data, and output the processed acoustic measurement output to the remote computing device.

In another example embodiment, a non-transitory computer-readable medium comprising computer-executable instructions is disclosed. The computer-executable instructions, when executed by a processor, may be configured to cause the processor to receive, at an edge device comprising the processor, a processing request transmitted by a computing device associated with acoustic measurement data, determine one or more processing parameters based on the processing request, retrieve the acoustic measurement data, generate processed acoustic measurement data based on the one or more processing parameters, generate processed acoustic measurement output based on the processed acoustic measurement data, and output the processed acoustic measurement output to the computing device.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is schematic diagram of an acoustic logging system, in accordance with aspects of the present disclosure;

FIG. 2 is a schematic diagram of an acoustic downhole tool that may be implemented in the acoustic logging system of FIG. 1, in accordance with aspects of the present disclosure;

FIG. 3 is a block diagram illustrating an edge acoustic processing system, in accordance with aspects of the present disclosure;

FIG. 4 is a flow diagram of a method for generating a processed waveform output, in accordance with aspects of the present disclosure;

FIG. 5 is a block diagram illustrating communication between an edge-based processing system and a remote processing system that may be performed in the edge acoustic processing system of FIGS. 1 and 2, in accordance with aspects of the present disclosure; and

FIG. 6 is a data flow diagram illustrating communication between a surface processing system, an edge-based processing system, and a remote processing system that may be performed in the edge acoustic processing system of FIGS. 1 and 2, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As used herein, the terms “connect,” “connection,” “connected,” “in connection with,” and “connecting” are used to mean “in direct connection with” or “in connection with via one or more elements”; and the term “set” is used to mean “one element” or “more than one element.” Further, the terms “couple,” “coupling,” “coupled,” “coupled together,” and “coupled with” are used to mean “directly coupled together” or “coupled together via one or more elements.” As used herein, the terms “up” and “down,” “uphole” and “downhole”, “upper” and “lower,” “top” and “bottom,” and other like terms indicating relative positions to a given point or element are utilized to more clearly describe some elements. Commonly, these terms relate to a reference point as the surface from which drilling operations are initiated as being the top (e.g., uphole or upper) point and the total depth along the drilling axis being the lowest (e.g., downhole or lower) point, whether the well (e.g., wellbore, borehole) is vertical, horizontal or slanted relative to the surface.

As used herein, the term “computing system” refers to an electronic computing device such as, but not limited to, a single computer, virtual machine, virtual container, host, server, laptop, and/or mobile device, or to a plurality of electronic computing devices working together to perform the function described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code.

In addition, as used herein, the terms “real time”, “real-time”, or “substantially real time” may be used interchangeably and are intended to describe operations (e.g., computing operations) that are performed without any human-perceivable interruption between operations. For example, as used herein, data relating to the systems described herein may be collected, transmitted, and/or used in control computations in “substantially real time” such that data readings, data transfers, and/or data processing steps occur once every second, once every 0.1 second, once every 0.01 second, or even more frequently, during operations of the systems (e.g., while the systems are operating). In addition, as used herein, the terms “continuous”, “continuously”, or “continually” are intended to describe operations that are performed without any significant interruption. For example, as used herein, control commands may be transmitted to certain equipment every five minutes, every minute, every 30 seconds, every 15 seconds, every 10 seconds, every 5 seconds, or even more often, such that operating parameters of the equipment may be adjusted without any significant interruption to the closed-loop control of the equipment.

In addition, as used herein, the terms “automatic”, “automated”, “autonomous”, and so forth, are intended to describe operations that are performed are caused to be performed, for example, by a computing system (i.e., solely by the computing system, without human intervention). Indeed, it will be appreciated that the data processing systems and control systems described herein may be configured to perform any and all of the data processing and control functions described herein automatically.

As mentioned above, conventional techniques for generating an acoustic well log generally include obtaining waveforms (e.g., acoustic measurement data, sonic data) at an electronic device at a wellsite and processing the waveforms to generate the acoustic well logs on a computing device located at the well site. At least in some instances, it may be advantageous for a user to observe the well site log from a remote computer. However, the raw waveform data utilizes a relatively large amount of memory, and thus transmitting the raw waveform data may take a time period that is unsuitable for the user. Additionally, it is presently recognized that it may be advantageous to offload at least some of the processing operations performed by the computing device at the well site to a remote computing device. For example, a remote computing device may have more processing capabilities, and thus, process the raw well data more quickly. Furthermore, at least in some instances, the user desiring to interact and monitor the acoustic well logs may not be at wellsite, and thus they may not be able to do so in an efficient manner.

Accordingly, the present disclosure is directed to acoustic processing at an edge component. The disclosed acoustic processing at an edge device technique includes systems and methods for communicating data between a data processing system at a well site and a remote computing device (i.e., not located at the well site or otherwise coupled via a network to the data processing system) via an edge-based processing system. In general, the edge-based processing system receives, retrieves, or otherwise obtains waveforms (e.g., acoustic measurement data, sonic data) obtained by an acoustic logging tool. In some embodiments, the edge-based processing system may retrieve the waveforms in one or more batches (e.g., micro batches), and processes the one or more batches to generate the well log data. In general, processing the waveforms to generate well log data includes techniques such filtering out separated reflected waves using one or more adaptive filters and/or obtaining acoustic slowness data to determine processed waveforms. In some embodiments, one or more image focusing techniques may be utilized after filtering out the separated waves. In any case, the edge-based processing system may generate well logs using the processed waveforms and transmit the well logs to a remote computing device that is not located at the well site. At least in some instances, the edge-based processing system may utilize processing parameters provided by the remote computing device (e.g., based on user input). In this way, the edge-based processing system may offload certain processing capabilities performed on a data processing system or device located at a wellsite to an edge device, thereby freeing up computational resources on the data processing system.

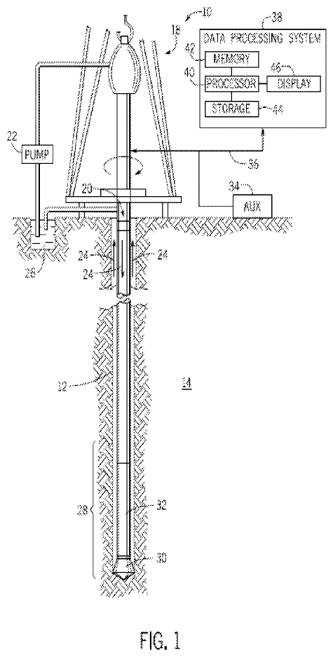

With the foregoing in mind, FIG. 1 illustrates a drilling system 10 that may employ the systems and methods of this disclosure. The drilling system 10 may be used to drill a borehole 12 into a geological formation 14. In the drilling system 10, a drilling rig 18 may rotate a drill string 20 within the borehole 12. As the drill string 20 is rotated, a drilling fluid pump 22 may be used to pump drilling fluid, which may be referred to as “mud” or “drilling mud,” downward through the center of the drill string 20, and back up around the drill string 20, as shown by reference arrows 24. At the surface, return drilling fluid may be filtered and conveyed back to a mud pit 26 for reuse. The drilling fluid may travel down to the bottom of the drill string 20 known as the bottom-hole assembly (BHA) 28. The drilling fluid may be used to rotate, cool, and/or lubricate a drill bit 30 that may be a part of the BHA 28. The fluid may exit the drill string 20 through the drill bit 30 and carry drill cuttings away from the bottom of the borehole 12 back to the surface.

The BHA 28 may include the drill bit 30 along with various downhole tools, such as an acoustic tool 32. The BHA 28 may thus convey the acoustic tool 32 through the geological formation 14 via the borehole 12. As described in greater detail herein, the acoustic tool 32 may be any suitable downhole tool that emits acoustic waves (e.g., sound waves, ultrasonic waves) within the borehole 12 (e.g., a downhole environment). The downhole tools, which may include the acoustic tool 32, may collect a variety of information relating to the geological formation 14 and the state of drilling in the borehole 12. For instance, the downhole tools may be logging-while drilling (LWD) tools that measure physical properties of the geological formation 14, such as density, porosity, resistivity, lithology, and so forth. Likewise, the downhole tools may be measurement-while-drilling (MWD) tools that measures certain drilling parameters, such as the temperature, pressure, orientation of the drill bit 30, and so forth.

As discussed further below, the acoustic tool 32 may receive energy from an electrical energy device or an electrical energy storage device, such as an auxiliary power source 34 or another electrical energy source to power the tool. In some embodiments, the acoustic tool 32 may include a power source within the acoustic tool 32, such as a battery system or a capacitor to store sufficient electrical energy to emit and/or receive acoustic waves.

Communications 36, such as control signals, may be transmitted from a data processing system 38 to the acoustic tool 32, and communications 36, such as data signals related to the results/measurements of the acoustic tool 32, may be returned to the data processing system 38 from the acoustic tool 32. The data processing system 38 may be any electronic data processing system that can be used to carry out the systems and methods of this disclosure. For example, the data processing system 38 may include one or more processors 40, which may execute instructions stored in memory 42 and/or storage 44. The memory 42 and/or the storage 44 of the data processing system 38 may be any suitable article of manufacture that can store the instructions. The memory 42 and/or the storage 44 may be read-only memory (ROM), random-access memory (RAM), flash memory, an optical storage medium, or a hard disk drive, to name a few examples. A display 46, which may be any suitable electronic display, may display images generated by the processor 40. The data processing system 38 may be a local component of the drilling system 10 (i.e., at the surface), within the acoustic tool 32 (i.e., downhole), a device located proximate to the drilling operation, and/or a remote data processing device located away from the drilling system 10 to process downhole measurements in real time or sometime after the data has been collected. In some embodiments, the data processing system 38 may be a portable computing device (e.g., tablet, smart phone, or laptop) or a server remote from the drilling system 10. In some embodiments, the acoustic tool 32 may store and process collected data in the BHA 28 or send the data to the surface for processing via communications 36 described above, including any suitable telemetry (e.g., electrical signals pulsed through the geological formation 14 or mud pulse telemetry using the drilling fluid).

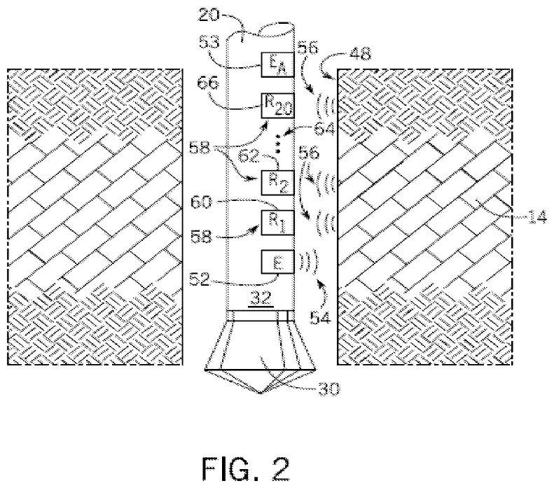

FIG. 2 illustrates a magnified schematic view of a portion of the BHA 28 near the acoustic tool 32. The acoustic tool 32 may obtain acoustic evaluation data relating to the presence of solids, liquids, or gases within the geological formation 14. For example, the acoustic tool 32 may obtain measurements of acoustic impedance, flexural attenuation, formation slowness, and/or mud slowness, which may be used to determine whether portions of the geological formation 14 are a solid, or not solid. The acoustic tool 32 may send the obtained measurements to the data processing system 38. As discussed in greater detail herein, processing acoustic data may involve separating different modes of acoustic measurements to provide more accurate evaluation of measured borehole 12 parameters.

The acoustic tool 32 may be suitable for operating in a “pulse echo” technique involving a single trans-receiver that pulses an acoustic beam at normal incidence to an inner surface 48 of the borehole 12 (e.g., the geological formation 14) and receives the return echo energy. Specifically, an emitter 52 (which may be a piezoelectric transducer) in the acoustic tool 32 may emit acoustic waves 54 out toward the geological formation 14. The emitted acoustic waves 54 may return from the inner surface 48 of the geological formation 14, thus generating detected waves 56, which may travel towards the acoustic tool 32. In some embodiments, the emitter 52 may receive and measure the detected waves 56. The detected waves 56 may vary depending on physical characteristics of the geological formation 14 (e.g., density, porosity). Measurements of acoustic evaluation data thus may be obtained, integrated, and/or processed by the data processing system 38 to determine physical characteristics of the geological formation 14.

To this end, the acoustic tool 32 may include one or more receiver transducers 58 (which may also be piezoelectric transducers). For example, the acoustic tool 32 may include a first receiver transducer 60, a second receiver transducer 62, multiple intermediate receiver transducers (as indicated by reference markers 64), and a final (e.g., here, twentieth) receiver transducer 66. In some embodiments, the acoustic tool 32 may include fewer or more than twenty receiver transducers 58. The acoustic tool 32 may be suitable for operating in a “pitch-catch” technique using the emitter 52 and the receiver transducers 58, where one or more emitters 52 and receiver transducers 58 are oriented to transmit acoustic signals and receive returned acoustic signals, respectively. Specifically, the emitter 52 in the acoustic tool 32 may emit acoustic energy 54 (e.g., sound waves, ultrasonic waves) out toward the geological formation 14 resulting in the detected waves 56, which are measured by the receiver transducers 58. In some embodiments, the acoustic tool 32 may include an additional emitter 53, which enables the acoustic tool 32 to operate using a borehole compensation (BHC) technique. In such embodiments, the receiver transducers 58 may be disposed between the emitter 52 and the additional emitter 53. For example, the additional emitter 53 may be disposed axially above the receiver transducers 58, while the emitter 52 may be disposed axially below the receiver transducers 58. As discussed above, the data processing system 38 may evaluate the acoustic data (e.g., the detected waves 56) received by the acoustic tool 32 to determine characteristics of the geological formation 14.

The acoustic tool 32 may emit acoustic waves of any suitable frequency for pitch-catch measurements. In some cases, the frequency or frequencies may be between 20 kilohertz (kHz) to 1 Megahertz (MHz). When the emitted frequency of the acoustic tool 32 is high, the acoustic tool 32 may acquire localized measurements corresponding to a certain borehole azimuth (e.g., a directional vector perpendicular to and relative to a central axis of the borehole 12). The acoustic tool 32 may thus acquire independent signals corresponding to measurements taken along different azimuths of the borehole 12. The signals may be evaluated (e.g., via the data processing system 38) and used to generate an azimuthal map of the geological formation 14 surrounding the borehole 12.

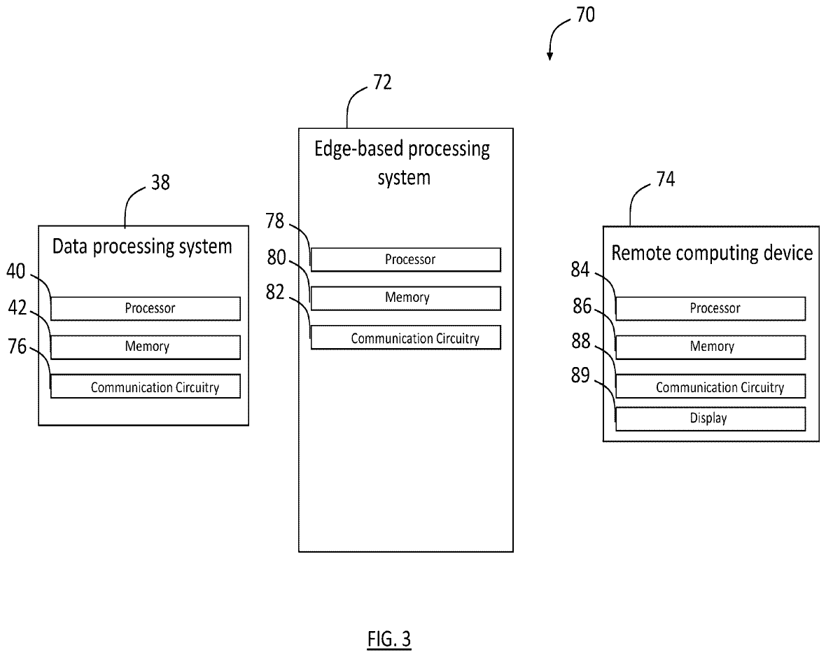

FIG. 3 is a block diagram illustrating an edge acoustic processing system, in accordance with aspects of the present disclosure. As shown in the illustrated embodiment, the edge acoustic processing system 70 includes a data processing system 38, an edge-based processing system 72, and a remote computing device 74. The various functional blocks shown in FIG. 3 may include hardware elements (including circuitry), software elements (including machine-executable instructions) or a combination of both hardware and software elements (which may be referred to as logic). It should be noted that FIG. 3 is merely one example of a particular implementation and is intended to illustrate the types of components that may be present in the data processing system 38, the edge-based processing system 72, and the remote computing device 74.

The data processing system 38 may include a processor 40, a memory 42, and communication circuitry 76 to enable the data processing system 38 to communicate with the edge-based processing system 72. In some embodiments, the data processing system 38 may store and/or execute an application in the memory 42 to be executed by the processor 40 that facilitates communication with the edge-based processing system 72.

The communication circuitry 76 may include, for example, communication circuitry for a personal area network (PAN), such as an ultra-wideband (UWB) or a BLUETOOTH® network, a local area network (LAN) or wireless local area network (WLAN), such as a network employing one of the IEEE 802.11x family of protocols (e.g., WI-FI®), and/or a wide area network (WAN), such as any standards related to the Third Generation Partnership Project (3GPP), including, for example, a 3^{rd} generation (3G) cellular network, universal mobile telecommunication system (UMTS), 4th generation (4G) cellular network, long term evolution (LTE®) cellular network, long term evolution license assisted access (LTE-LAA) cellular network, 5^{th} generation (5G) cellular network, and/or New Radio (NR) cellular network, a 6^{th} generation (6G) or greater than 6G cellular network, a satellite network, a non-terrestrial network, and so on.

The edge-based processing system 72 may include a processor 78, a memory 80, and communication circuitry 82 to enable the edge-based processing system 72 to communicate with the data processing system 38 and/or the remote computing device 74. In some embodiments, the edge-based processing system 72 may store and/or execute an application in the memory 80 to be executed by the processor 78 that facilitates communication with the data processing system 38 and/or the remote computing device 74. The communication circuitry 82 may include generally similar features as described above with respect to the communication circuitry 76.

The remote computing device 74 may include a processor 84, a memory 86, and communication circuitry 88 to enable the remote computing device 74 to communicate with the edge-based processing system 72. In some embodiments, the remote computing device 74 may store and/or execute an application in the memory 86 to be executed by the processor 84 that facilitates communication with the edge-based processing system 72. The communication circuitry 88 may include generally similar features as described above with respect to the communication circuitry 82 and 76. As shown, the remote computing device 74 includes a display 89.

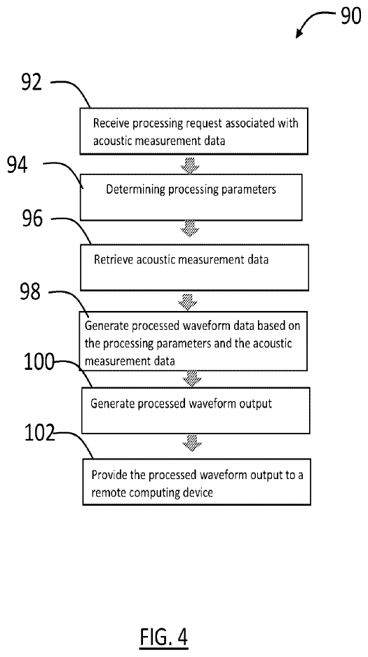

FIG. 4 is a flow diagram of a method 90 for generating a downhole operation output based on acoustic measurement data (e.g., acoustic waveform data, sonic data), in accordance with aspects of the present disclosure. In general, certain process blocks performed in the method 90 may be performed by the processor 78 of the edge-based processing system 72. However, for simplicity, the actions described below are being described with respect to the edge-based processing system 72 rather than the processor 78. Moreover, certain process blocks described below may be performed in a different order than that illustrated, and, indeed, in some embodiments, certain process blocks may be skipped altogether.

At block 92, the edge-based processing system 72 receives a processing request associated with the acoustic measurement data. In some embodiments, the processing request may include one or more processing parameters that generally indicate how the acoustic measurement data is to be processed. In general, the processing request is transmitted by a remote computing device 74 and ultimately received by the edge-based processing system 72.

At block 94, the edge-based processing system 72 determines the one or more processing parameters based on the processing request. In some embodiments, the edge-based processing system 72 may retrieve the one or more processing parameters from the memory 86. For example, the one or more processing parameters in the memory 86 may indicate default parameters or processing parameters associated with a prior processing request (i.e. receives before the current processing request). Additionally or alternatively, in embodiments where the one or more processing parameters are included with the processing request, the edge-based processing system 72 may identify those parameters and proceed to block 96

At block 96, the edge-based processing system 72 retrieves or otherwise obtains the acoustic measurement data. In general, the edge-based processing system 72 retrieves the acoustic measurement data from the data processing system 38. For example, the memory 42 of the data processing system 38 may store the acoustic measurement data in a manner such that the acoustic measurement data is accessible by the edge-based processing system 72. For example, during logging, acoustic measurement data, such as acoustic waveform data, is sent to the data processing system 38 (e.g., at the surface) and stored in a file format (e.g., a Digital Log Interchange Standard (DLIS) format). At block 98, the edge-based processing system 72 generates processed waveform data using the acoustic waveform data (e.g., input waveform data). That is, after the edge-based processing system 72 receives the processing request (e.g., at block 92), the edge-based processing system 72 may perform operations such as loading the DLIS for the acoustic waveform data from the data processing system 38, storing the resulting DLIS for the processed input waveform data, and streaming the result DLIS to a cloud storage. In some embodiments, the edge-based processing system 72 may store the instructions for processing the input waveform data using a container (e.g., a virtualization of an operating system). For example, the instructions for processing the input waveform data may be containerized in a microservice then run as a cluster. In some embodiments, the microservice may access the input waveform data using an application programming interface (API). In some embodiments, the edge-based processing system 72 may process the input waveform data while the DLIS data is being built. That is, upon receiving a first input waveform data, the edge-based processing system 72 may process that data to generate a first processed input waveform. Subsequently, once a second input waveform data is retrieved by the edge-based processing system 72, the edge-based processing system 72 may process the second input waveform data to generate a second processed input waveform.

At block 100, the edge-based processing system 72 generates a processed waveform output. In general, the processed waveform output may be configured to cause the display 89 of the remote computing device 74 to display an acoustic well log. At block 102, the edge-based processing system 72 transmits the processed waveform output to the remote computing device 74. In some embodiments, the processed waveform output may be stored in a cloud storage, thereby facilitating calibration and communication of the processed waveform data between multiple remote computing devices (e.g., via a network). In this way, a user utilizing a remote computing device 74 may access results and interpret while logging and can make processing request.

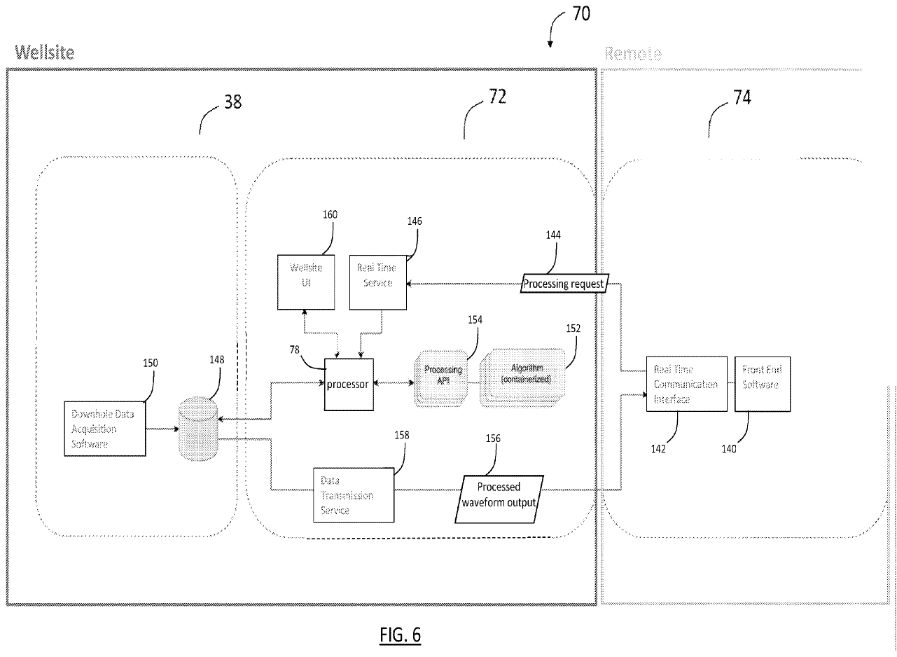

FIG. 5 is a block diagram illustrating communication between an edge-based processing system 72 and a remote computing device 74 that may be performed in the edge acoustic processing system of FIGS. 1 and 2, in accordance with aspects of the present disclosure. In general, the disclosed techniques may be applied to different processing techniques that utilize acoustic measurements, for example, p-wave and s-wave (P&S) slowness processing, sonic imaging, well integrity evaluation (e.g., analysis of a casing or liner using acoustic measurements), and so on. FIG. 5 shows an example embodiment using a cement evaluation technique.

As shown in the illustrated embodiment, the edge-based processing system 72, at block 106, generates a dispersion plot 108 and/or map data 110 based on a free-pipe section log 104. In general, the free-pipe log 104 may be well log data associated with a particular depth range (e.g., covering between 100 to 300 ft of depth). Moreover, the free-pipe log 106 represents a well log in the absence of the pipe, thereby enabling a user to remotely calibrate the acoustic tool 32. The edge-based processing system 72 may then transmit the dispersion plot 108 and/or the map data 110 to the remote computing device 74.

After receiving the dispersion plot 108 and/or map data 110, the remote computing device 74 may generate, at block 112, a visualization of the dispersion plot 108 and/or the map data 110. In turn, the remote computing device 74 may determine, at block 114, one or more calibration parameters 116 to use in generating one or more logs (e.g., acoustic measurement outputs based on the processed acoustic measurement data), as discussed in more detail below. In some embodiments, the remote computing device 74 may cause the display 89 (as shown in FIG. 3) of the remote computing device 74 to display a graphical user interface (GUI) depicting the visualization that aids the user in performing certain operations. The visualization may include one or more selectable features that the user may select (e.g., by providing user input 118) to adjust and/or select the one or more calibration parameters 116. In some embodiments, the visualization may include selectable features that enable a user to select one or more of the acoustic measurement data (e.g., DLIS data). As shown, the one or more calibration parameters 116 may be transmitted to the edge-based processing system 72. Although block 114 is shown as being performed by the remote computing device 74, it should be noted that in some embodiments, block 114 may be performed by the edge-based processing system 72. For example, the remote computing device 74 may transmit data corresponding to selected calibration parameters 116 to the edge-based processing system 72 based on the user input 118.

After receiving the one or more calibration parameters 116 (e.g., or determining the one or more calibration parameters 116), the edge-based processing system 72 may generate, at block 120, an initial log 122 based on the one or more calibration parameters 116. In turn, the edge-based processing system 72 may transmit the initial log 122 to the remote computing device 74, thereby causing the display 89 of the remote computing device 74 to display the initial log 122. At block 124, the remote computing device 74 may generate a quality control (QC) log output 126 based on the initial log 122. In general, the QC log output 126 may be generated based on the user input 118 (e.g., additional user input) and generally indicates whether the one or more calibration parameters 116 should be adjusted. For example, the initial log 122 may be used by the remote computing device 74 to calibrate for potential drift that may occur during logging by the acoustic tool 32. In any case, the initial log 122 may be used to verify that subsequently generated acoustic measurement data (e.g., main log processed data and/or repeat log processed data as described in more detail below) that are ultimately used for output logs 114 (e.g., acoustic measurement outputs based on the processed acoustic measurement data) are generated within a suitable error threshold. In any case, the QC log output 126 may be transmitted to the edge-based processing system 72.

After receiving the QC log output 126, the edge-based processing system 72 may generate modified logs 130 (e.g., final logs) based on the QC log output 126. In general, the modified logs 130 may include log processed data and/or repeats of the log processed data. In some embodiments, block 114, block 120, block 124, and block 128 may be repeated until the modified logs 130 are within a suitable error threshold (e.g., account for any drift of the acoustic tool 32).

FIG. 6 is a data flow diagram illustrating communication between a surface processing system, an edge processing system, and a remote processing system that may be performed in the edge acoustic processing system of FIGS. 1 and 2, in accordance with aspects of the present disclosure. More specifically, FIG. 6 shows a high-level architecture of edge processing. In the illustrated embodiment, the edge acoustic processing system 70 includes a data processing system 38, an edge-based processing system 72, and a remote computing device 74.

The remote computing device 74 includes a front-end software application 140 and a real-time communication interface 142. In general, the front-end software application 140 may receive a processing request to analyze or retrieve acoustic measurement data and/or processor waveform data. The real-time communication interface 142 may transmit a processing request 144 (e.g., which may include processing parameters), which is received by a real time (RT) service 146 of the edge-based processing system 72. In general, the RT service 146 may be a software application that is utilized by the processor 84 and the communication circuitry 88 of the remote computing device 74 to communicate data with the edge-based processing system 72.

The processing request 144 may indicate or include processing parameters such as a particular file or data type to retrieve from the data processing system 38. In some embodiments, the processing request 144 may indicate a DLIS file selection, and one or more processing parameters. Additionally or alternatively, the processing request 144 may indicate calibration parameters such as a calibration depth (i.e., a depth at which the acoustic tool 32 may be calibrated and/or a depth range corresponding to the free-pipe log 104), data indicating a particular free-pipe log 104 (e.g., as described above with respect to FIG. 5), and/or a calibration template. In general, a calibration template may include parameters for calibrating the acoustic measurement data, such as a calibration curve, reference data associated with standardized solutions, and the like. In any case, a processor 78 of the edge-based processing system 72 may load, retrieve, or otherwise obtain acoustic measurement data from a storage component 148 of the data processing system 38. In general, the acoustic measurement data may be acquired by the acoustic tool 32 via a downhole data acquisition software 150. By way of example, the acoustic measurement data may be transmitted by way of a Windows file share or any other suitable means of data transfer. In some embodiments, the processor 78 of the edge-based processing system 72 may obtain the acoustic measurement data from the storage component 148 in multiple batches, where each batch is a subset of the entire acoustic measurement data. In this way, the edge-based processing system 72 may regulate the computational resources used to process the acoustic measurement data.

As shown, the edge-based processing system 72 may utilize a containerized algorithm 152 and/or processing application programming interface (API) 154 that includes the instructions for processing the acoustic measurement data. For example, the containerized algorithm 152 may include the adaptive filters and/or slowness data used to process a waveform. In any case, the edge-based processing system 72 may store the result DLIS (e.g., the processed waveform data) in the storage component 148 of the data processing system 38 and/or a storage component 148 of the edge-based processing system 72. Then, the edge-based processing system 72 may transmit the processed waveform data and/or a processed waveform output 156 that generally includes the processed waveform data to the remote computing device 74. In one or more embodiments, the processed waveform data and/or the processed waveform output 156 may be transmitted to the remote computing device 74 by way of a data transmission (DT) service 158 of the edge-based processing system 72. In some embodiments, the edge-based processing system 72 may utilize a wellsite user interface (UI) 160 to facilitate retrieving data from the storage component 148.

For example, the edge-based processing system 72 may stream the processed waveform output 156 to be displayed on the display 89 of the remote computing device 74. Accordingly, a user may visualize the processed waveform output 156 in the form of an acoustic well-log, which may aid the user in determining actions related to oil and gas operations. In some embodiments, a data acquisition software runs in a virtual machine, and then the remote computing device 74 generates the processed waveform data using a Kubernetes cluster. In any case, the result DLIS is transferred to the remote computing device 74, thereby enabling a user to access, interpret and/or request additional processing. By way of example, the result DLIS may be transferred to the remote computing device 74 by way of a cloud storage. In some embodiments, the data processing system 38 and the edge-based processing system 72 may be on a wellsite, while the remote computing device 74 is in a location separate from the wellsite. Accordingly, the communication between the remote computing device 74 and the edge-based processing system 72 may aid a user in analyzing data obtained at the wellsite, such as by the acoustic tool 32.

It should be noted that, although FIG. 6 shows different software applications being utilized to communicate certain data (e.g., a processing request 144, processed waveform output 156, data stored in the storage component 148, and the like), it should be noted that any number of suitable software applications may be utilized to perform these processes. That is, FIG. 6 shows a non-limiting example of an implementation of the disclosed techniques.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A method, comprising:
receiving, via one or more processors associated with an edge device, a processing request transmitted by a computing device associated with acoustic measurement data;
determining, via the one or more processors, one or more processing parameters based on the processing request;
retrieving, via the one or more processors, the acoustic measurement data;
generating, via the one or more processors, processed acoustic measurement data based on the one or more processing parameters;
generating, via the one or more processors, a processed acoustic measurement output based on the processed acoustic measurement data; and
outputting, via the one or more processors, the processed acoustic measurement output to the computing device.

2. The method of claim 1, wherein the acoustic measurement data comprises a waveform associated with a geological location.

3. The method of claim 1, wherein the acoustic measurement data is based on data acquired by a downhole acoustic logging tool.

4. The method of claim 1, comprising retrieving the acoustic measurement data from an additional computing device different from the computing device.

5. The method of claim 1, wherein the processed acoustic measurement output is configured to cause a display of the computing device to display an acoustic well log.

6. The method of claim 1, comprising generating, via the one or more processors, the processed acoustic measurement data using a containerized algorithm.

7. The method of claim 1, wherein outputting, via the one or more processors, the processed acoustic measurement output to the computing device comprises streaming the processed acoustic measurement data.

8. The method of claim 1, wherein the acoustic measurement data comprises a Digital Log Interchange Standard (DLIS) format.

9. The method of claim 1, wherein retrieving, via the one or more processors, the acoustic measurement data comprises retrieving a plurality of batches of the acoustic measurement data.

10. An edge-based acoustic processing system, comprising:
a remote computing device; and
an edge-based processing system communicatively coupled to the remote computing device, wherein the edge-based processing system comprises one or more processors, one or more memory devices, and wherein the one or more processors are configured to:
receive a processing request transmitted by the remote computing device associated with acoustic measurement data;
determine one or more processing parameters based on the processing request;
retrieve the acoustic measurement data;
generate processed acoustic measurement data based on the one or more processing parameters;
generate a processed acoustic measurement output based on the processed acoustic measurement data; and
output the processed acoustic measurement output to the remote computing device.

11. The edge-based acoustic processing system of claim 10, wherein the remote computing device comprises a portable computing device.

12. The edge-based acoustic processing system of claim 10, wherein generating processed acoustic measurement data based on the one or more processing parameters comprises applying one or more adaptive filters.

13. The edge-based acoustic processing system of claim 10, wherein the processed acoustic measurement output is configured to cause a display of the remote computing device to display an acoustic well log.

14. The edge-based acoustic processing system of claim 10, comprising a data processing system disposed at a wellsite, wherein the data processing system is communicatively coupled to the edge-based processing system via a network.

15. The edge-based acoustic processing system of claim 10, wherein the one or more processors are configured to generate a graphical user interface for the edge-based processing system

16. A non-transitory computer-readable medium comprising computer-executable instructions that, when executed by a processor, are configured to cause the processor to:
receive, at an edge device comprising the processor, a processing request transmitted by a computing device associated with acoustic measurement data;
determine one or more processing parameters based on the processing request;
retrieve the acoustic measurement data;
generate processed acoustic measurement data based on the one or more processing parameters;
generate processed acoustic measurement output based on the processed acoustic measurement data; and
output the processed acoustic measurement output to the computing device.

17. The non-transitory computer-readable medium of claim 16, wherein the instructions, when executed by the processor, cause the processor to generate the processed acoustic measurement data using a containerized algorithm.

18. The non-transitory computer-readable medium of claim 16, wherein the acoustic measurement data comprises a Digital Log Interchange Standard (DLIS) format.

19. The non-transitory computer-readable medium of claim 16, wherein the acoustic measurement data comprises waveform data.

20. The non-transitory computer-readable medium of claim 16, wherein the processed acoustic measurement output is configured to cause a display of the computing device to display an acoustic well log.
